(19) United States
(12) Patent Application Publication
(10) Pub. No.: US 2016/0303561 A1
(43) Pub. Date: Oct. 20, 2016

(54) FOLDABLE MICROPLATE

(71) Applicant: GE HEALTHCARE BIO-SCIENCES AB, Uppsala (SE)

(72) Inventors: Nils Norrman, Uppsala (SE); Henrik Ostlin, Uppsala (SE)

(21) Appl. No.: 15/101,234

(22) PCT Filed: Nov. 25, 2014
(86) PCT No.: PCT/EP2014/075567

§ 371 Date: Jun. 2, 2016

(30) Foreign Application Priority Data
Dec. 13, 2013 (GB) 1322082.7

(51) Int. Cl. B01L 3/00

(52) U.S. Cl. CPC B01L 3/50855; B01L 2300/0829

(57) ABSTRACT

The present invention provides a microplate comprised of multiwell strips connected in such a way as to permit the microplate to unfold and to pass in a linear fashion past a fraction collector and then re-fold back into a microplate configuration. Furthermore, the invention provides for the use of the microplates of the invention in a variety of different laboratory methods.

### TECHNICAL FIELD OF THE INVENTION

The present invention relates to the field of disposables for laboratories, e.g. for chemical and biological laboratories. Particularly the invention provides a microplate comprised of multiwell strips connected in such a way as to permit the microplate to unfold and to pass in a linear fashion past a fraction collector and then re-fold back into a microplate configuration. Furthermore, the invention provides for the use of the microplates of the invention in different methods.

### DESCRIPTION OF RELATED ART

A convenient feature of commercially-available liquid chromatography systems is the provision of a fraction collection valve located in the liquid flow line immediately after the detector. Collection can be done when peaks appear on the chromatogram recorded by the detector, enabling specific components of the chromatography to be collected for further assessment. Known fraction collectors use standard test tubes, e.g. Eppendorf tubes, arranged to allow them to pass substantially linearly past the fraction collection valve. Following fraction collection the fractions are typically transferred into a microplate (or another device) for further processing or analysis. This transfer can be carried out manually or more conveniently, in particular where there are a large number of fractions, using an automated system.

A disadvantage of the known system is that there are multiple stages involved in fraction collection and subsequent processing. There is therefore a need for a simpler process that overcomes this disadvantage.

### SUMMARY OF THE INVENTION

In one aspect the present invention provides a microplate (1) comprising a plurality multiwell strips (2) wherein each of said plurality of multiwell strips (2) is connected to the adjacent multiwell strip (2′) by means of a coupler (3) wherein said coupler (3) comprises at least two pivots allowing pivoting between adjacent strips.

In one embodiment of said microplate (1) the pivots of said coupler (3) comprise two substantially C-shaped or O-shaped outer clamp members (4, 4′) which are interconnected back-to-back at a linkage (5).

In another embodiment of the microplate (1) each clamp member (4, 4′) cooperates with a complementary formation at each end of each strip (2, 2′) to provide said pivoting.

In one embodiment of the microplate (1) of the invention each of said multiwell strips (2) comprises a frame (7) that supports a plurality of wells (8).

In one embodiment of the microplate (1) of the invention said frame comprises an upper surface supported by legs and wherein said upper surface comprises a plurality of holes therethrough for receipt of said plurality of wells.

In one embodiment of the microplate (1) of the invention said frame (7) comprises two opposing longitudinal side walls (9, 9′) each having an upper edge (10, 10′) and a lower edge (11, 11′) wherein said longitudinal side walls (9, 9′) are connected by two opposing end walls (12, 12′) each having an upper edge (13, 13′) and a lower edge (14, 14′).

In one embodiment of the microplate (1) of the invention said upper edges (10, 10′, 13, 13′) are aligned.

In one embodiment of the microplate (1) of the invention said lower edges (11, 11′, 14, 14′) are aligned.

In one embodiment of the microplate (1) of the invention each of said wells (8) comprises a top end (15) defining an opening (16) and a bottom end (17) defining a base (18).

In one embodiment of the microplate (1) of the invention the bottom end (17) of said wells (8) protrudes below the lower edges (11, 11′, 14, 14′) of said frame.

In one embodiment of the microplate (1) of the invention said base is U-shaped, V-shaped or flat.

In one embodiment of the microplate (1) of the invention each of said multiwell strips (2) comprises 2 to 64 wells, preferably 4 to 32 wells, more preferably 6 to 8 wells.

In one embodiment of the microplate (1) of the invention said coupler (3) is formed integrally as one piece.

In another aspect the present invention provides for the use of the microplate (1) of the invention in research procedures and diagnostic techniques.

In one embodiment of the use of the invention the research procedure and/or diagnostic technique is selected from the group consisting of genetic typing, amplification of nucleic acids, polymerase chain reaction (PCR) based methods, enzyme-linked immunosorbent assay (ELISA), sequencing, high content screening, crystallography, melt curve determination, hybridisation related assays, in vitro translation, in vitro transcription, cell culturing, liquid handling systems, storage of samples and storage of compounds.

### BRIEF DESCRIPTION OF THE FIGURES

FIG. 1 illustrates a microplate of the invention in use for fraction collection in a linear direction.

FIG. 2 shows a partial underside view of part of a multiwell strip with a coupler attached.

FIG. 3 is a partial underside view of how two multiwell strips are connected together with a coupler showing the multiwell strips aligned linearly.

FIG. 4 is another partial underside view of two multiwell strips connected together with a coupler showing the multiwell strips at right angles to each other.

FIG. 5 shows a coupler suitable for use with the present invention to connect two multiwell strips together.

### DETAILED DESCRIPTION OF THE PREFERRED EMBODIMENTS

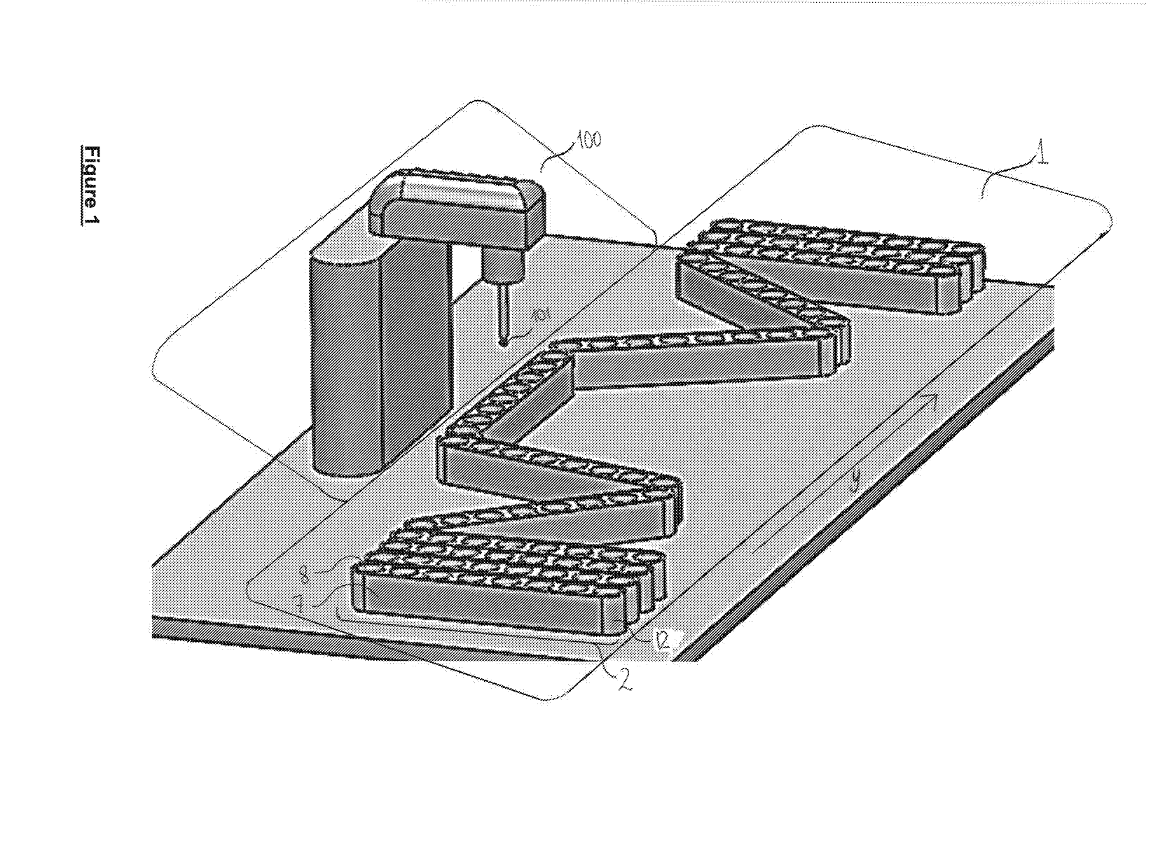

FIG. 1 shows a microplate 1 of the invention in a partially unfolded state while being used to collect fractions from a fraction collector device 100. Linear movement of the microplate wells 8 underneath the outlet 101 of the fraction collector device 100 is achieved as each multiwell strip 2 of the microplate 1 moves in direction “y”. Motion may be achieved in a straightforward manner, e.g. having a single drive wheel close to the outlet 101 of the fraction collector device 100. It is furthermore useful to have retaining walls placed around the strips to guide movement in the desired direction and to enable folding back to the original microplate format.

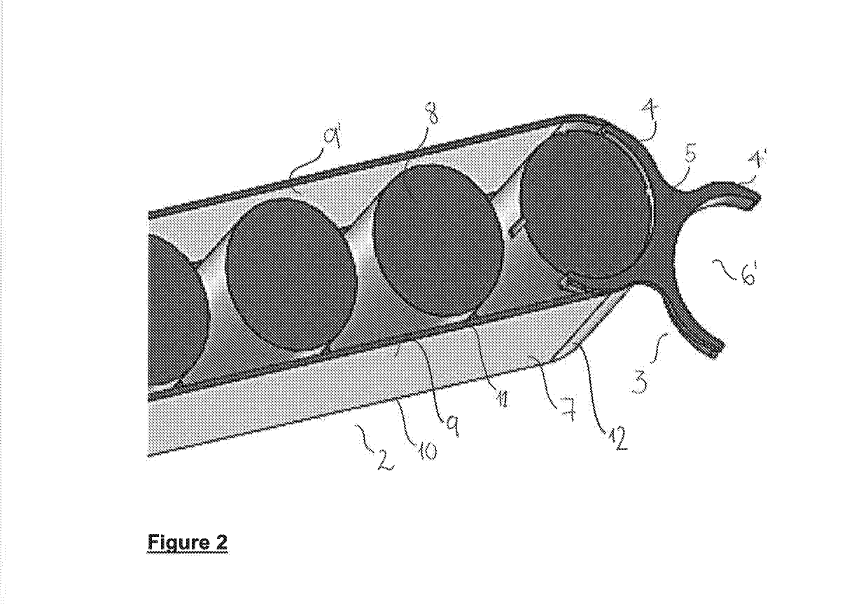

FIG. 2 shows a partial view of the underside of a multiwell strip 2 of the microplate 1 of the invention with a coupler 3 attached at one end. The coupler 3 can be seen to include two C-shaped outer clamp members 4 and 4′ with respective open mouths 6 and 6′ connected at linkage 5. The underside of a number of wells (one of which is indicated as 8) can be seen as well as the frame 7 of the multiwell strip 2 which is comprised of two side walls 9 and 9′ and two end walls (one of which can be seen in FIG. 2 as 12). The upper edge 10 and the lower edge 11 of one of the side walls 9 are also indicated in FIG. 2.

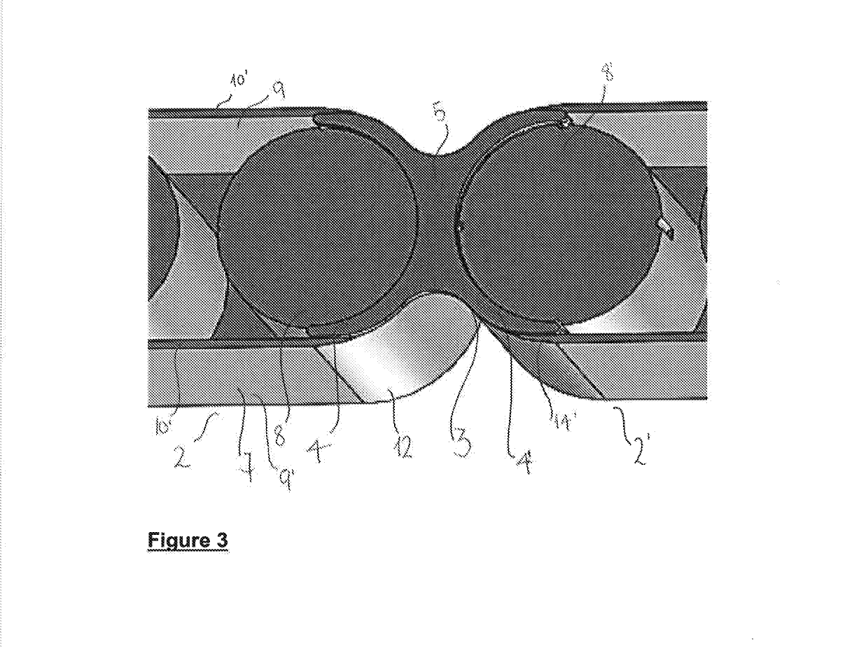

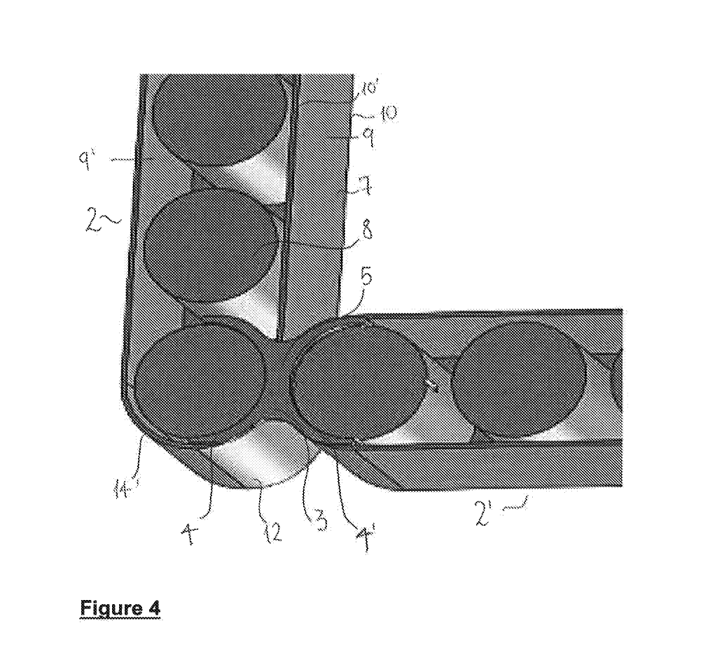

FIG. 3 is an underside view of two multiwell strips 2 and 2′ of a microplate according to the present invention connected with a coupler 3 in an end-to-end linear relationship. It can be seen how each clamp member 4 and 4′ of the coupler 3 snap fits around the outside of each end well 8 and 8′ of each multiwell strip 2 and 2′ so as to connect the multiwell strips together. In this arrangement, the multiwell strips 2 and 2′ can move in a hinge-like fashion relative to each other, i.e. can be in the illustrated end-to-end linear arrangement, in a parallel side-by-side arrangement, and anywhere in between these two extremes. In FIG. 4 the two multiwell strips 2 and 2′ can be seen arranged half way between the end-to-end linear arrangement and the side-by-side parallel arrangement. The connected multiwell strips can therefore either be folded together all in a side-by-side arrangement to form a microplate that can be used in a variety of standard laboratory procedures, or they can be unfolded in order to pass by a fraction collection device or other device from which samples are dispensed.

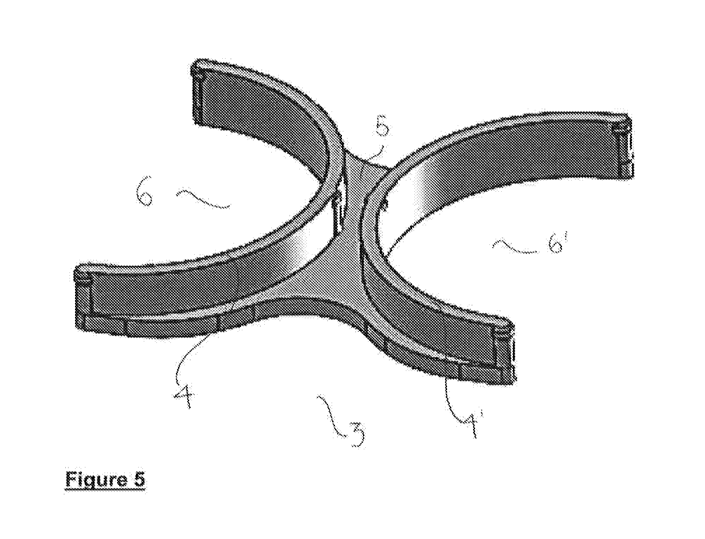

The skilled person will recognise that a variety of coupler configurations are suitable for use in the present invention as long as they comprise at least two pivots allowing pivoting between adjacent strips. A C-shaped clamp member can snap fit onto the end of a multiwell strip, whereas for example an O-shaped clamp member can provide a more permanent coupling arrangement. A coupler 3 is illustrated on its own in FIG. 5 in order to more clearly show two C-shaped outer clamp members 4 and 4′, having open mouths 6 and 6′, interconnected at linkage 5. As can be seen, the illustrated coupler 3 is formed integrally as one piece.

Microplates and microwells are well known and widely used in the field of life sciences. A “microplate” (also commonly known as a “microtitre plate” or “microwell plate”) is a flat plate with multiple “wells” used as small test tubes. The microplate has become a standard tool in analytical research and clinical diagnostic testing laboratories. The microplate according to the present invention is designed for the use in a variety of well-known systems. These systems have standard dimensions for the measurements of multiwell strips with respect to e.g. the distance between the wells, the dimensions or design of the wells. The skilled person is aware of the standards, which can be found e.g. at: http://www.slas.org/default/assets/File/ANSI_SLAS_1-2004_FootprintDimensions.pdf) and which govern various characteristics of a microplate. In one embodiment of the microplate of the present invention the spacing of the wells meet(s) the standards prescribed by the American National Standards Institute (ANSI). In another embodiment the spacing of one well to another with respect to the centre of the wells is selected from the group consisting of 9 mm, 4.5 mm and 2.25 mm. In another embodiment of the microplate of the present invention the spacing of the well positions is the spacing according to the spacing for 96-well microplates as set out by ANSI and wells with a total volume of 50 μL. In another embodiment the wells have a total height of about 7.35±0.1 mm and a maximum inner diameter of about 3.25±0.1 mm

Microplates are manufactured in a variety of materials. The most common is polystyrene, used for most optical detection microplates. It can be coloured white by the addition of titanium dioxide for optical absorbance or luminescence detection or black by the addition of carbon for fluorescent biological assays. Polypropylene is used for the construction of plates subject to wide changes in temperature, such as storage at −80° C. and thermal cycling. It has excellent properties for the long-term storage of novel chemical compounds. Polycarbonate is cheap and easy to mould and has been used for disposable microplates for the polymerase chain reaction (PCR) method of deoxyribonucleic acid (DNA) amplification. Cyclo-olefins are now being used to provide microplates which transmit ultraviolet light for use in newly developed assays. There are also microplates constructed from solid pieces of glass and quartz for special applications.

The frame of a multiwell strip can consist of a first material and the wells can consist of a second material. The materials of the multiwell strip may vary and can be adapted to the needs, e.g. thermal resistant, thermal diffusivity or rigidity of the material. For example the first material may selected from the group comprising amorphous plastic partially crystallizing, polycarbonate (PC), cycloolefin copolymer (COC; Topas™ COC), acrylonitrile butadiene styrene (ABS), acetyl copolymer (Delrin), nylon, filled polymers, glass filled polymers, talc filled polymer, cycloolefin polymer (COP). The second material may be for example selected from the group comprising of polypropylene (PP), polyethylene (PE) and polycarbonate (PC). The skilled artisan will recognize that any combinations of first and second material can be used according to the needs and the purposed use of the microplate of the invention. In one embodiment of the present invention the first material is polycarbonate (PC) and the second material is polypropylene (PP). In another embodiment the first material is cycloolefin copolymer (COC; Topas™ COC) and the second material is polypropylene (PP), and in a further embodiment the first material is cycloolefin polymer (COP) and the second material is polypropylene (PP).

In one embodiment of the present invention, the multiwell strip comprises 2 to 64 wells, preferably 4 to 32 wells, more preferably 6 to 8 wells. In a further embodiment of the present invention the spacing of the well positions corresponds to microplates as set out by ANSI and wells with a total volume of 50 μL. In another embodiment the wells have a total height of about 7.35±0 1 mm and a maximal inner diameter of about 3.25±0.1 mm. A microplate can have 6, 24, 96, 384 or even 1536 sample wells arranged in a 2:3 rectangular matrix. Some microplates have even been manufactured with 3456 or even 9600 wells. In one embodiment of the present invention, the microplate comprises 6 to 1536 wells, preferably 6 to 384 wells. In a further preferred embodiment the microplate according to the present invention has 96 wells.

The enclosed Figures show wells having a flat bottom, but wells can also be U-shaped or V-shaped. A flat bottom well type is ideal for precise optical measurements and for microscopic applications. The measuring light source is not deflected by the well profile. Excellent optical properties as a result of the flat bottom of the wells. U-shaped bottom well are ideally suited for agglutination tests as they have no sharp corners, meaning they can be pipetted easily and cleanly. A V-shaped (also referred to as “conical”) bottom well is ideally suited for applications in which the entire sample volume must be pipetted off. Precise pipetting is facilitated since the sample collects particularly well at the bottom. These wells are also ideally suited for the storage of samples.

Each well of a microplate typically holds somewhere between tens of nanolitres to several millilitres of liquid. They can also be used to store dry powder or as racks to support glass tube inserts. Microplates can be stored at low temperatures for long periods, may be heated to increase the rate of solvent evaporation from their wells and can even be heat-sealed with foil or clear film. Another microplate sealing method involves use of dedicated microplate covers, typically made from silicone rubber and useful where samples are to be added or taken out using needle penetration as the material reseals when the needle is removed. Microplates with an embedded layer of filter material were developed in the early 1990s by several companies, and today, there are microplates for just about every application in life science research which involves filtration, separation, optical detection, storage, reaction mixing or cell culture.

It will be acknowledged by those with ordinary skills in the art that the microplate and/or multiwell strips according to the present invention can be used in many different laboratory applications. For example, the multiwell strip or microplate may be used for storage of compounds or samples or may be used in research procedures and/or diagnostic techniques. Microplates are used generally in different types of liquid handling systems, in particular robotic systems, designed to perform multiple iterations of applications and/or analyses. Various biological research and clinical diagnostic procedures and techniques require or are facilitated by an array of wells or tubes in which multiple samples are disposed for qualitative and quantitative assays or for sample storage and retrieval. The term “sample” as used herein refers to any kind of substance or substance mixture to be analysed. A sample may be a sample originating from an environmental source, such as a plant sample, a water sample, a soil sample, or may be originating from a household or industrial source or may also be a food or beverage sample. A sample in the meaning of the invention may also be a sample originating from a biochemical or chemical reaction or a sample originating from a pharmaceutical, chemical, or biochemical composition. A sample may also be a forensic or medical sample such as bodily fluids or tissue samples.

The present invention is advantageous because it omits manual stages when moving from “linear” collection (along x axis only) or processing of samples to further processing or analysis in a standard microplate format (xy processing). Furthermore, the present invention provides the link between a number of common lab operations with the well-established microplate format for rapid and efficient analysis.

Particular advantages are to be gained for sample transfer. A number of companies have developed robots to specifically handle microplates. These robots may be liquid handlers which aspirate or dispense liquid samples from and to these plates, or “plate movers” which transport them between instruments, plate stackers which store microplates during these processes, plate hotels for longer term storage, plate washers for processing plates, plate thermal sealers for applying heat seals, de-sealers for removing heat seals, or microplate incubators to ensure constant temperature during testing. Instrument companies have designed plate readers which can detect specific biological, chemical or physical events in samples stored in these plates.

1. A microplate comprising a plurality multiwell strips wherein each of said plurality of multiwell strips is connected to the adjacent multiwell strip by means of a coupler wherein said coupler comprises at least two pivots allowing pivoting between adjacent strips.

2. The microplate as defined in claim 1 wherein the pivots of said coupler comprise two substantially C-shaped or O-shaped outer clamp members which are interconnected back-to-back at a linkage.

3. The microplate as defined in claim 2 wherein each clamp member cooperates with a complementary formation at each end of each strip to provide said pivoting.

4. The microplate as defined in claim 1 wherein each of said multiwell strips comprises a frame that supports a plurality of wells.

5. The microplate as defined in claim 4 wherein said frame comprises an upper surface supported by legs and wherein said upper surface comprises a plurality of holes therethrough for receipt of said plurality of wells.

6. The microplate as defined in claim 4 wherein said frame comprises two opposing longitudinal side walls each having an upper edge and a lower edge wherein said longitudinal side walls are connected by two opposing end walls each having an upper edge and a lower edge.

7. The microplate as defined in claim 6 wherein said upper edges are aligned.

8. The microplate as defined in claim 7 wherein said lower edges are aligned.

9. The microplate as defined in claim 1 wherein each of said wells comprises a top end defining an opening and a bottom end defining a base.

10. The microplate as defined in claim 9 wherein the bottom end of said wells protrudes below the lower edges of said frame.

11. The microplate as defined in claim 10 wherein said base is U-shaped, V-shaped or flat.

12. The microplate as defined in claim 11 wherein each of said multiwell strips comprises 2 to 64 wells, preferably 4 to 32 wells, more preferably 6 to 8 wells.

13. The microplate as defined in claim 12 wherein said coupler is formed integrally as one piece.

14. Use of a microplate as defined in claim 13 in research procedures and diagnostic techniques.

15. The use as defined in claim 14 wherein the research procedure and/or diagnostic technique is selected from the group consisting of genetic typing, amplification of nucleic acids, polymerase chain reaction (PCR) based methods, enzyme-linked immunosorbent assay (ELISA), sequencing, high content screening, crystallography, melt curve determination, hybridisation related assays, in vitro translation, in vitro transcription, cell culturing, liquid handling systems, storage of samples and storage of compounds.
